(19) United States
(12) Patent Application Publication
(10) Pub. No.: US 2025/0173689 A1
(43) Pub. Date: May 29, 2025

(54) COMPUTER-READABLE STORAGE MEDIUM AND METHOD FOR MATCHING BLOCKCHAIN-BASED TOKENS TO DIFFERENT ELECTRONIC WALLETS ON BASIS OF EVENT

(71) Applicant: NCSOFT Corporation, Seoul (KR)

(72) Inventors: Doyun KIM, Gyeonggi-do (KR); Seungjoon AHN, Gyeonggi-do (KR); Hanmin LEE, Seongnam-si (KR)

(73) Assignee: NCSOFT Corporation, Seoul (KR)

(21) Appl. No.: 19/040,459

(22) Filed: Jan. 29, 2025

Related U.S. Application Data
(63) Continuation of application No. PCT/KR2022/013744, filed on Sep. 14, 2022.

(51) Int. Cl. G06Q 20/06; G06Q 20/36

(52) U.S. Cl. CPC G06Q 20/065; G06Q 20/363

(57) ABSTRACT

A method of an electronic device, includes, identifying, using communication circuitry of the electronic device, a plurality of users related to an event; receiving, from at least one of the plurality of users, first information related to performance of the event; obtaining a token that corresponds to the received first information, and that is linked to a blockchain distributed to a plurality of external electronic devices; and based on identifying that the token is transacted based on the blockchain, and based on the first information corresponding to the token, matching electronic wallets corresponding to each of the plurality of users, to second information indicating that a virtual currency is allocated based on a transaction of the token.

### CROSS-REFERENCE TO RELATED APPLICATION

This application is a by-pass continuation application of International Application No. PCT/KR2022/013744, filed on Sep. 14, 2022, in the Korean Intellectual Property Office, the disclosure of which is incorporated by reference herein its entirety.

### BACKGROUND

### 1. Field

The disclosure relates to a computer-readable storage medium and a method for matching blockchain-based tokens to different electronic wallets on basis of an event.

### 2. Description of Related Art

An electronic device may provide at least one service to a plurality of external electronic devices through a network. The electronic device may generate an event by using the at least one service. The electronic device may configure a ‘decentralized autonomous organization’ (DAO) using at least some of the plurality of external electronic devices related to the event based on the generated event.

An electronic device may generate an event provided by the electronic device based on a DAO configured with a plurality of electronic devices. The electronic device may require a method for matching a token obtained by performing the event to each of the plurality of electronic devices based on the DAO. However, the related art fails to provide such method.

The technical problem to be achieved in the disclosure is not limited to that described above, and other technical problems not mentioned herein will be clearly understood by those having ordinary knowledge in the art to which the present disclosure belongs, from the following description.

### SUMMARY

Provided is an electronic device that may generate an event provided by the electronic device based on a ‘decentralized autonomous organization’ (DAO) configured with a plurality of electronic devices. The electronic device may match a token obtained by performing the event to each of electronic wallets of users corresponding to the plurality of electronic devices based on the DAO.

According to an aspect of the disclosure, a computer readable storage medium storing one or more programs, wherein the one or more programs that, when executed by a processor of an electronic device, are configured to: identify, using communication circuitry of the electronic device, a plurality of users related to an event; receive first information related to performance of the event from at least one of the plurality of users; obtain a token, corresponding to the received first information, and linked to a blockchain distributed to a plurality of external electronic devices; and based on identifying that the token is transacted based on the blockchain, and based on the first information corresponding to the token, match electronic wallets corresponding to each of the plurality of users, to second information indicating that a virtual currency is allocated based on a transaction of the token.

According to an aspect of the disclosure, a method of an electronic device, includes, identifying, using communication circuitry of the electronic device, a plurality of users related to an event; receiving, from at least one of the plurality of users, first information related to performance of the event; obtaining a token that corresponds to the received first information, and that is linked to a blockchain distributed to a plurality of external electronic devices; and based on identifying that the token is transacted based on the blockchain, and based on the first information corresponding to the token, matching electronic wallets corresponding to each of the plurality of users, to second information indicating that a virtual currency is allocated based on a transaction of the token.

According to an aspect of the disclosure, a computer readable storage medium storing one or more programs, wherein the one or more programs that, when executed by a processor of an electronic device, are configured to: based on receiving, using communication circuitry of the electronic device, first information for generating an event from one of a plurality of users, generate the event; receive second information related to performance of the generated event from one of the plurality of users; based on at least one of the first information or the second information, obtain a token, wherein the token is generated by the performance of the event, and the token is linked to a blockchain distributed to a plurality of external electronic devices; and based on identifying completion of the event, match the token to electronic wallets corresponding to each of the plurality of users.

The effects that can be obtained from the present disclosure are not limited to those described above, and any other effects not mentioned herein will be clearly understood by those having ordinary knowledge in the art to which the present disclosure belongs, from the following description.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an example block diagram of an electronic device in a network environment, according to an embodiment;

FIG. 2 is an example signal flowchart between a plurality of electronic devices for obtaining tokens, according to an embodiment;

FIG. 3 illustrates an example state in which an electronic device according to an embodiment matches a token linked to a blockchain to a plurality of electronic wallets;

FIG. 4 illustrates an example screen for generating an event by an external electronic device according to an embodiment;

FIG. 5 illustrates an example screen for an external electronic device according to an embodiment to participate in an event; and

FIG. 6 is an example flowchart indicating an operation in which an electronic device according to an embodiment matches electronic wallets to a token.

### DETAILED DESCRIPTION

The electronic device (or external electronic device) according to one or more embodiments may be one of various types of electronic devices. The electronic devices may include, for example, a portable communication device (e.g., a smartphone), a computer device, a portable multimedia device, a portable medical device, a camera, a wearable device, a server, or a home appliance. According to an embodiment of the disclosure, the electronic devices are not limited to those described above.

One or more embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

One or more embodiments as set forth herein may be implemented as software (e.g., the program) including one or more instructions that are stored in a storage medium that is readable by a machine (e.g., the electronic device). For example, a processor of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™ or App Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

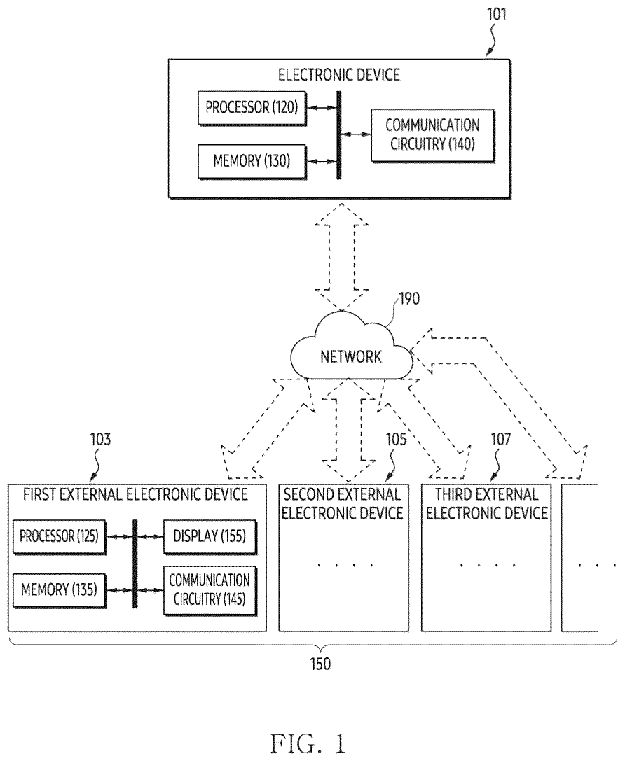

FIG. 1 is an example block diagram of an electronic device in a network environment, according to an embodiment. Referring to FIG. 1, the environment illustrated in FIG. 1 may include the electronic device 101, a plurality of external electronic devices 150, and a network 190. The electronic device 101 may be connected to the plurality of external electronic devices 150 based on a wired network and/or a wireless network. For example, the wired network may include a network such as the Internet, a local area network (LAN), a wide area network (WAN), Ethernet or a combination thereof. For example, the wireless network may include a network such as long term evolution (LTE), 5G new radio (NR), wireless fidelity (WiFi), Zigbee, near field communication (NFC), Bluetooth, Bluetooth low-energy (BLE), or a combination thereof.

FIG. 1 illustrates that the electronic device 101 is directly connected to the plurality of external electronic devices 150 through the network 190, but the disclosure is not limited thereto. For example, the electronic device 101 and the plurality of external electronic devices 150 may be indirectly connected through one or more routers and/or one or more access points (APs).

According to an embodiment, the electronic device 101 may include a server of a service provider. For example, the electronic device 101 may include one or more personal computers (PCs) and/or workstations. For example, the electronic device 101 may obtain a token by linking to an external object (e.g., a blockchain). For example, the electronic device 101 may match at least one electronic wallet to information which indicates assigning a virtual currency based on a transaction of the obtained token.

In an embodiment, the blockchain accessed by the electronic device 101 may mean a group of information distributed to different electronic devices connected in the network and serially connected based on a hash value. In an embodiment, the electronic device 101 may store at least a portion of the information included in the group. However, an embodiment is not limited thereto. As an example, the electronic device 101 may distribute and store at least the portion of the information in nodes included in the network. Information stored in a specific electronic device among electronic devices storing the group's information may include other information serially connected to the information, data for identifying other electronic device storing the other information in the network, and data for authenticating a serial connection between the information and the other information. The data for authenticating the serial connection between the information and the other information may include a hash value of the information or the other information. As an example, the hash value may be obtained based on a transaction (e.g., a minimum unit of a transaction) indicating a transaction history. As an example, the hash value may be obtained based on a specified length. As an example, the hash value may be obtained based on at least one transaction.

According to an embodiment, the electronic device 101 may store information related to a smart contract (e.g., a blockchain-based contract execution technology) of subscribers subscribed to a service based on the electronic device 101 in the blockchain. For example, the information related to the smart contract may include a transaction condition and/or a transaction detail. The information related to the smart contract may be stored in the blockchain, based on the transaction. For example, the electronic device 101 may initiate an execution of the transaction using data (e.g., Ethereum Virtual Machine (EVM) byte code) included in the blockchain in a state of identifying that the transaction condition of the smart contract have been completed. As an example, the smart contract may be implemented based on the token (e.g., a virtual currency). By using the smart contract, the electronic device 101 may prevent at least one user related to the transaction from changing the information related to the transaction. The electronic device 101 may maintain integrity of information related to the transaction by preventing the information from being changed.

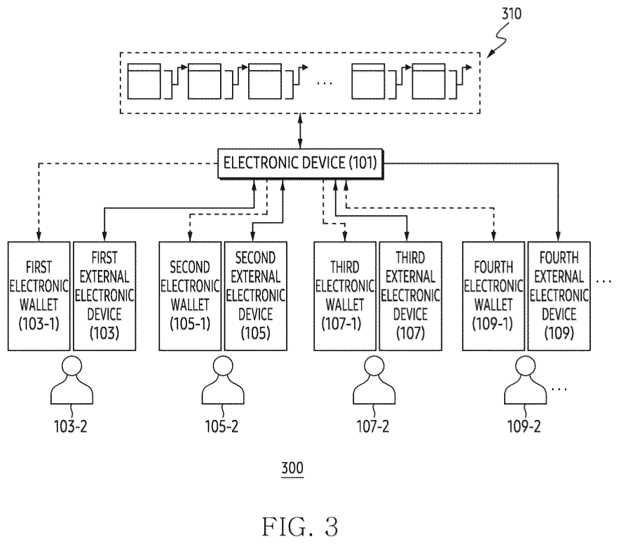

An operation in which the electronic device 101 allocates a token to electronic wallets corresponding to each of users based on the smart contract will be described later in FIG. 3.

In an embodiment, the token obtained by the electronic device 101 and linked with the blockchain may be or correspond to a currency (e.g., an electronic currency or a virtual currency) available in a service provided by the electronic device 101. For example, the token may be or correspond to a virtual currency provided by the blockchain. As an example, the token may include non-fungible token (NFT), a currency available in the service provided by a server (e.g., game money, fungible token (FT)), a non-transferable token (NTT), and/or a crypto currency. As an example, the token may be generated based on ERC-20 and/or ERC-721. As an example, the token may include information on a location where the token is stored, information on a creator of the token, information on an owner of the token, and information on a transaction detail of the token. As an example, the electronic device 101 may (be configured to) distribute and store at least some of the information related to the token in the blockchain. However, the disclosure is not limited to the above-described embodiments.

The electronic device 101 according to an embodiment may be at least one server that provides a service for an application. For example, the electronic device 101 may include an application server, a charge processing server, a database that stores user information of the application, a database that stores data for executing the application, and/or a database that stores data related to a payment transaction that occur in the application. For example, the application server, the charge processing server, the database that stores the user information, the database that stores the data for executing the application, and the database that stores the data related to the payment transaction may be implemented as a single physical machine or multiple physical machines.

According to an embodiment, the application server may process a calculation request related to the application received from a first external electronic device 103, which is a client device, based on linking to the database that stores the data for executing the application, and transmit information on the result of the process to the first external electronic device 103. The calculation request related to the application received from the first external electronic device 103 may include information on generation and/or performance of the event.

For example, the event may be generated by a plurality of external electronic devices 150 in at least one service provided by the electronic device 101 to the plurality of external electronic devices 150. For example, the event may be provided to subscribers (e.g., the users of the plurality of external electronic devices 150) of the service provided by electronic device 101. For example, the event may be provided to the subscribers based on the service based on the blockchain. As an example, the users of each of the plurality of external electronic devices 150 may use the event to obtain token (e.g., a reward). As an example, the users of each of the plurality of external electronic devices 150 may use the event to achieve a common goal (e.g., co-mission). As an example, at least one of users may request the electronic device 101 to generate an available event in the service (e.g., a game service) provided by the electronic device 101. The event may be an example of the event related to a multi-bus.

According to an embodiment, the application server may register the users of the plurality of external electronic devices 150 that are a client device based on linking to the database that stores the user information of the application, or execute a user authentication based at least on a relationship between account information received from at least one (e.g., first external electronic device 103) of the plurality of external electronic devices 150 and account information stored in the database that stores the user information.

According to an embodiment, the charge processing server may process the payment transaction caused during execution of the application based on linking to the database that stores the data related to the payment transaction. In case that the payment transaction is related to account transfer or a credit card payment, the charge processing server may further link to the electronic device for a bank or a credit card company for processing the payment transaction. For example, the charge processing server may identify the information of the plurality of electronic wallets corresponding to each of the plurality of external electronic devices (150) to process a digital asset (e.g., non-fungible token (NFT)). For example, the charge processing server may process the payment transaction based on the virtual currency.

Referring to FIG. 1, according to an embodiment, the electronic device 101 may include at least one of a processor 120, a memory 130, or communication circuitry 140. The processor 120, the memory 130, and/or the communication circuitry 140 may be electronically and/or operably coupled with each other by a component such as a communication bus. A type and/or the number of a hardware component included in the electronic device 101 are not limited to those illustrated in FIG. 1. For example, the electronic device 101 may include only a portion of the hardware component illustrated in FIG. 1.

Throughout the disclosure, the processor 101 may indicate or correspond to one or more processors. The one or more processors may include one or more of a central processing unit (CPU), a graphics processing unit (GPU), an accelerated processing unit (APU), a many integrated core (MIC), a field-programmable gate array (FPGA), a digital signal processor (DSP), a neural processing unit (NPU), a hardware accelerator, or a machine learning accelerator. The one or more processors are able to perform control of any one or any combination of the other components of the computing device, and/or perform an operation or data processing relating to communication. The one or more processors execute one or more programs stored in a memory. The one or more processors may be implemented as one or more multi-core processors that include one or more cores (e.g., homogeneous multi-cores or heterogeneous multi-cores). When a plurality of cores are included in a processor, each of the cores includes a cache memory, and a common cache shared by the cores may be included in the processor. Each of the cores may independently read and execute program instructions or each of the cores may read and execute one or more portions of program instructions. In embodiments of the disclosure, a processor may refer to a system-on-a-chip (SoC) in which one or more cores and other electronic components are integrated, a single core processor, a multicore processor, or a core included in the single core processor or the multicore processor, wherein the core may be implemented as a CPU, a GPU, an APU, an MIC, an FPGA, a DSP, an NPU, a hardware accelerator, or a machine learning accelerator, but the embodiments of the disclosure are not limited thereto. The processor 120 of the electronic device 101 according to an embodiment may include the hardware component for processing data based on one or more instructions.

According to an embodiment, the memory 130 of the electronic device 101 may include the hardware component for storing the data and/or the instructions inputted to or outputted from the processor 120. For example, the memory 130 may include volatile memory such as random-access memory (RAM) and/or non-volatile memory such as read-only memory (ROM). For example, the volatile memory may include at least one of dynamic RAM (DRAM), static RAM (SRAM), Cache RAM, and pseudo SRAM (PSRAM). For example, the non-volatile memory may include at least one of programmable ROM (PROM), erasable PROM (EPROM), electrically erasable PROM (EEPROM), flash memory, hard disk, compact disk, and embedded multimedia card (eMMC).

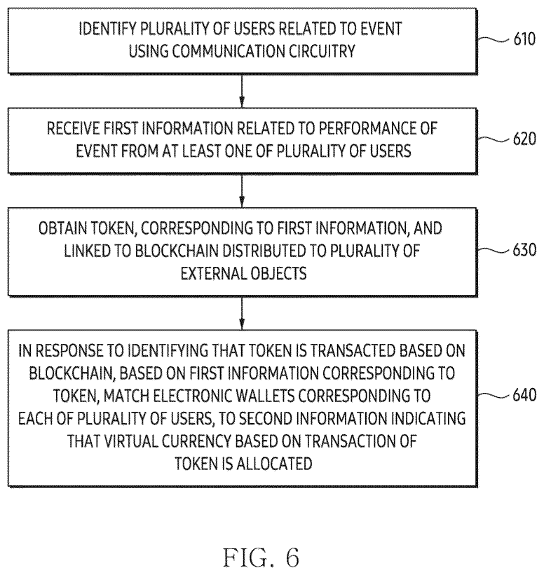

According to an embodiment, in the memory 130 of the electronic device 101, one or more instructions indicating an operation to be performed by the processor 120 on data may be stored. A set of the instructions may be referred to as firmware, an operating system, a process, a routine, a sub-routine and/or an application. For example, the electronic device 101 and/or the processor 120 of the electronic device 101 may perform the operation of FIG. 6 by executing the set of the plurality of instructions distributed in the form of the application.

The communication circuitry 140 of the electronic device 101 according to an embodiment may include the hardware component for supporting transmission and/or reception of a signal between the electronic device 101 and the plurality of external electronic devices 150. For example, the communication circuitry 140 may include at least one of a modem (MODEM), an antenna, and an optic/electronic (O/E) converter. For example, the communication circuitry 140 may support the transmission and/or reception of the signal based on a various type of protocol such as Ethernet, local area network (LAN), wide area network (WAN), wireless fidelity (WiFi), Bluetooth, Bluetooth low energy (BLE), ZigBee, long term evolution (LTE), and 5G new radio (5G NR).

According to an embodiment, the plurality of external electronic devices 150 may be owned by different users. For example, the first external electronic device 103, a second external electronic device 105, and/or a third external electronic device 107 may include a personal computer (PC) such as a laptop or desktop and a smart accessory such as a smartphone, a smart pad, a tablet personal computer (PC), a smartwatch, and a head-mounted device (HMD). For example, the plurality of external electronic devices 150 may be an example of the electronic device that receives the service (e.g., an online game service) through the electronic device 101. Each of users using the first external electronic device 103, the second external electronic device 105, and/or the third external electronic device 107 may be subscribers of the service provided by the electronic device 101.

Among the plurality of external electronic devices 150 according to an embodiment, the first external electronic device 103 may include at least one of a processor 125, a memory 135, communication circuitry 145 and a display 155. The processor 125, the memory 135, or the communication circuitry 145 and/or the display 155 may be electronically and/or operably coupled with each other by the component such as the communication bus. The type and/or the number of the hardware component included in the first electronic device 103 are not limited to those illustrated in FIG. 1. For example, the first electronic device 103 may include only the portion of the hardware component illustrated in FIG. 1. For example, processor 125 may correspond to the processor 120 of the electronic device 101. For example, the memory 135 may correspond to the memory 130 of the electronic device 101. The communication circuitry 145 may correspond to the communication circuitry 145 of the electronic device 101.

The display 155 of the first external electronic device 103 according to an embodiment may be controlled by a controller such as the processor 125 and may output visualized information to the user. The display 155 may include a flat panel display (FPD), and/or electronic paper. The FPD may include a liquid crystal display (LCD), a plasma display panel (PDP), and/or one or more light emitting diodes (LEDs). The LED may include an organic LED (OLED). For example, display 155 may be used to display an image obtained by the processor 125 or an image obtained by a display driving circuitry. For example, the first external electronic device 103 may display the image on a portion of the display 155 under the control of the display driving circuitry. However, the disclosure is not limited to thereto.

According to an embodiment, each of the plurality of external electronic devices 150 (e.g., the second external electronic device 105) may include at least some or all of the components included in the first external electronic device 103. Each of the plurality of external electronic devices 150 may be independently configured by including at least some or all of the components included in the first external electronic device 103.

As described above, the electronic device 101 may receive the information from at least one of the plurality of external electronic devices 150 by establishing a communication link with the plurality of external electronic devices 150 through the network 190. The information may include the information related to the event.

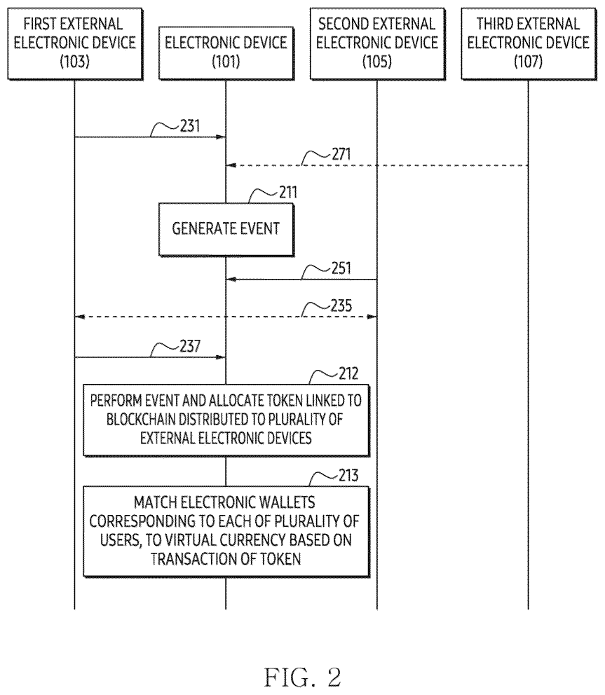

For example, the electronic device 101 may obtain the token linked to the external object (e.g., the blockchain) based on the performance of the event. For example, the electronic device 101, in response to (or based on) identifying that the token is transacted, based on the information, may allocate the virtual currency based on a transaction of the token to electronic wallets corresponding to each of users of the plurality of external electronic devices 150. The electronic device 101 may transmit the reward (e.g., the virtual currency) to the electronic wallets based on identifying the end of the event, independently of a signal (e.g., a signal requesting allocation of the virtual currency) transmitted from at least one of the plurality of external electronic devices 150. Hereinafter, in FIG. 2, a signal flowchart for transmitting and receiving information related to the event using the communication link between the electronic device 101 and the plurality of external electronic devices 150 will be described later.

FIG. 2 is an example signal flowchart between a plurality of electronic devices for obtaining a token, according to an embodiment. Referring to FIG. 2, a plurality of signals transmitted and received between the plurality of electronic devices are illustrated. The electronic device 101 may be referred to the electronic device 101 of FIG. 1. A first external electronic device 103 may be referred to the first external electronic device 103 of FIG. 1. A second external electronic device 105 may be referred to the second external electronic device 105 of FIG. 1. A third external electronic device 107 may be referred to the third external electronic device 107 of FIG. 1. The electronic device 101 and each of the plurality of external electronic devices 103, 105, and 107 may establish respectively different communication links through a network (e.g., the network 190 of FIG. 1), using a communication circuitry (e.g., the communication circuitry 140 of FIG. 1 or the communication circuitry 145 of FIG. 1).

The electronic device 101 according to an embodiment may receive a signal 231 from the first external electronic device 103. As an example, the first external electronic device 103 may include the plurality of electronic devices corresponding to the plurality of users for suggesting an event. For example, the signal 231 may include information on the event. For example, the information about the event may include a content of the event, a cost of generating the event, and/or share ratio of each of the plurality of users suggesting the event. As an example, the information on the event may include the content, a solution, and/or a goal for completing the event. For example, the cost of generating the event may include the token (e.g., NFT, or FT) corresponding to a virtual currency. As an example, the electronic device 101 may identify the share ratio for each of the plurality of users of the event based on a token ratio corresponding to the virtual currency provided by each of the plurality of users.

The electronic device 101 according to an embodiment may receive a signal 271 from the third external electronic device 107. For example, the third external electronic device 107 may include the plurality of electronic devices corresponding to one or more users designated for monitoring the event. For example, the signal 271 may include data for identifying the one or more users designated for monitoring the event from among the plurality of users corresponding to the plurality of electronic devices (e.g., the plurality of external electronic devices 150 of FIG. 1). For example, the electronic device 101 may allocate at least some of the tokens obtained based on performance of the event to each of electronic wallets corresponding to the one or more designated users, based on the data. For example, the signal 271 may be omitted based on the content of the event. According to an embodiment, the electronic device may refrain from allocating at least some of the tokens to each of the electronic wallets corresponding to the one or more users designated for monitoring the event based on the omitted signal 271.

The electronic device 101 according to an embodiment may generate the event in operation 211 based on receiving the signal 231 and/or the signal 271. For example, the electronic device 101 may identify the information on the event included in the signal 231 and/or the signal 271. As an example, the information of the event may include the content of the event and the cost (or token) for generating the event. For example, the electronic device 101 may store the information of the event as a resource file (or format), based on an operating system, included in the electronic device 101. For example, the information on the event may include the information on Table 1 to be described later.

TABLE 1

| Line number | Tag |
|---|---|
| 1 | id: STRING |
| 2 | title: STRING |
| 3 | issued by: MEMBER_ID |
| 4 | smart check id: SMARTCHECK_ID |
| 5 | info: { } |
| 6 | deliverable: [ {condition: STRING, token: TOKEN_ID}] |
| 7 | payer payment: [ {token type: LABEL( ), amount: |
| | DOUBLE, payer: MEMBER_ID, }] |
| 8 | participants: [ { member: MEMBER_ID, role: |
| | LABEL(ISSUER, PAYER, PARTICIPANT, |
| | MANAGER) }] |
| 9 | state: |

For example, the above Table 1 may be displayed in a various format based on the operating system included in the electronic device 101 according to an embodiment. Referring to Table 1, a tag “id: STRING” of line number 1 and/or a tag “title: STRING” of line number 2 may be an example of a designated text indicating that a character string is included in “id” and/or “title”.

For example, the character string may mean a sequential sequence of symbols. Referring to Table 1, a tag “issued by: MEMBER_ID” of line number 3 may mean the information of the user (e.g., the user of the first external electronic device 103) suggesting the event. The signal 231 may include the user's information.

Referring to Table 1, a tag “smart check id: SMARTCHECK_ID” of line number 4 may mean the information indicating that the token related to the performance of the event is allocated to each of the electronic wallets corresponding to the plurality of users.

Referring to Table 1, a tag “info: { }” of line number 5 may mean the text for the user (e.g., the user of the first external electronic device 103) suggesting the event to introduce the event to the users of the plurality of external electronic devices 150 through the electronic device 101.

Referring to Table 1, a tag of line number 6 “deliverable: [{condition: STRING, token, TOKEN_ID}]” may be an example of a designated text indicating a type of token obtained by the electronic device 101 by linking to the blockchain, based on the performance of the event, and/or condition for obtaining the token.

Referring to Table 1, a tag of line number 7 “payer payment: [{token type: LABEL( ), amount: DOUBBLE, payer: MEMBER_ID,}]” may be the designated text indicating the information on the token different from the token provided by the user of the first external electronic device 103 and the information on the user who provided the different token to generate the event.

Referring to Table 1, a tag of line number 8 “participants: [{member: MEMBER_ID, role: LABEL (ISSUER, PAYER, PARTICIPANT, MANAGER)}]” may be an example of the designated text indicating information on the users (e.g., the user of the second external electronic device 105) who participated in the event. Referring to Table 1, a tag “state” of line number 9 may mean the designated text indicating a state different from a state related to the event. However, the disclosure is not limited to the above-described embodiment. The electronic device 101 according to an embodiment may provide the information on the event to the plurality of external electronic devices (e.g., the plurality of external electronic devices 150 of FIG. 1) through the network (e.g., the network 190 of FIG. 1) based on generating the event.

The electronic device 101 according to an embodiment may receive a signal 251 including the information for participating in the event from the second external electronic device 105. For example, the second external electronic device 105 may include the plurality of electronic devices corresponding to the plurality of users for participating in the event from among the plurality of external electronic devices 150. As an example, the plurality of users may provide at least one token to participate in the event. As an example, the electronic device 101 may obtain the at least one token provided by the plurality of users for participating in the event. For example, the electronic device 101 may identify the information on the plurality of users for participating in the event based on the signal 251. As an example, the electronic device 101 may store the information on the plurality of users for participating in the event in a text format designated in the tag of line number 8 in Table 1 described above.

The first external electronic device 103 and/or the second external electronic device 105 according to an embodiment may transmit and/or receive a signal 235 for changing the information on the event. For example, the change of the information on the event may mean the change in the content of the event, the type of the token based on the performance of the event, and/or the period of the event. For example, the first external electronic device 101 may transmit a signal 237 including the information on the changed event to the electronic device 101. The signal 237 may include the information requesting an initiation of the event. As an example, the signal 235 may be omitted according to the content of the event.

The electronic device 101 according to an embodiment may perform the event in operation 212 and allocate the token linked to the blockchain distributed to the plurality of external objects. For example, the electronic device 101 may obtain the information on some (e.g., the user corresponding to the second external electronic device 105) of the plurality of users related to the event according to the performance of the event.

For example, the electronic device 101 may obtain the token linked to the blockchain based on the performance of the event. For example, the token may be issued (or minted) as non-fungible token (NFT). For example, the electronic device 101 may identify that the token is transacted. As an example, the electronic device 101 may receive the information for displaying a platform for transacting the token from the plurality of external electronic devices (e.g., the first external electronic device 103 and/or the second external electronic device 105). For example, the electronic device 101 may obtain the virtual currency based on a transaction of the token, based on identifying that the token is transacted. For example, the token may be allocated differently according to the users corresponding to the plurality of external electronic devices (e.g., the first external electronic device 103 and/or the second external electronic device 105) related to the event.

In operation 213, the electronic device 101 according to an embodiment may match the electronic wallets corresponding to each of the plurality of users, to the virtual currency based on the transaction of the token. For example, the electronic device 101 may match the virtual currency based on the transaction of the token to the electronic wallets corresponding to each of the plurality of users, based on the information on the users participating in the event from among the plurality of users and/or the share ratio of each of the plurality of users suggesting the event obtained according to the performance of the event. An operation in which the electronic device 101 matches the virtual currency based on the transaction of the token to each of the electronic wallets based on at least one piece of information will be described later in FIG. 3.

The electronic device 101 according to an embodiment may provide at least one service (e.g., a game service, a metaverse service, and/or a chat service) to the plurality of external electronic devices (e.g., the plurality of external electronic devices 150 of FIG. 1) through the network (e.g., the network 190 of FIG. 1). For example, the users of each of the plurality of external electronic devices may be subscribers to use the service. For example, the electronic device 101 may receive the signal 231 from the first external electronic device 103 for generating a quest (or the event) provided to the users of the service (e.g., the game service, the metaverse service, and/or the chat service) provided by the electronic device 101. The signal 231 may include the information on the token provided by users suggesting the quest, which may be used in the service. As an example, the electronic device 101 may provide the token to the users participating in the quest as a reward for completion of the quest, based on the performance of the quest.

As described above, the electronic device 101 may receive the signal (e.g., the signal 231) from the plurality of external electronic devices (e.g., the first external electronic device 131, the second external electronic device 105, and/or the third external electronic device 107). The signal may include the information on the event available in the service provided by the electronic device 101. The information on the event may include the information on a first token for generating the event and/or a second token according to the performance of the event. Based on the information, the electronic device 101 may match the tokens to the electronic wallets corresponding to each of the plurality of users (e.g., the users of the first external electronic device 103 and/or the second external electronic device 105) related to the event. The electronic device 101 may allocate the token to the electronic wallet corresponding to each of users of the plurality of external electronic devices, independently of receiving the signal for requesting the token from the plurality of external electronic devices based on the performance of the event. The electronic device 101 may provide events corresponding to each of the plurality of services to the plurality of external electronic devices (e.g., the plurality of external electronic devices 150 of FIG. 1) based on the plurality of services (e.g., the game service, the metaverse service, the chat service). The electronic device 101 may provide the token available in the plurality of the services to users of each of the plurality of services based on the performance of the event. Hereinafter, in FIG. 3, an operation in which the electronic device 101 obtains the token by linking to the blockchain based on the event and matches the obtained token to the electronic wallets of each of the plurality of users will be described later.

FIG. 3 illustrates an example state in which an electronic device according to an embodiment matches a token linked to a blockchain to a plurality of electronic wallets. Referring to FIG. 3, the electronic device 101 may be referred to the electronic device 101 of FIG. 1. A first external electronic device 103 may be referred to the first external electronic device 103 of FIG. 1. A second external electronic device 105 may be referred to the second external electronic device 105 of FIG. 1. A third external electronic device 107 may be referred to the third external electronic device 107 of FIG. 1. Referring to FIG. 3, state 300 may include a blockchain 310 linked to the electronic device 101, the plurality of users 103-2, 105-2, 107-2 corresponding to the plurality of external electronic devices 103, 105, 107 and the plurality of electronic wallets 103-1, 105-1, 107-1 corresponding to the plurality of users.

In state 300 according to an embodiment, the plurality of external electronic devices (e.g., the plurality of external electronic devices 150 of FIG. 1) including the electronic device 101, the first external electronic device 103, the second external electronic device 105, and/or the third external electronic device 107 may configure a ‘decentralized autonomous organization’ (DAO) linked through at least one network (e.g., the network 190 of FIG. 1). Based on an event generated by the electronic device 101, the electronic device 101 may use the token provided from the plurality of users (e.g., 103-2, 105-2, 107-2) using the plurality of the external electronic devices to perform the event. The electronic device 101 may obtain a token different from the token by linking to the blockchain 310 by using the token.

The electronic device 101 according to an embodiment may link at least one data to the blockchain 310 through a communication circuitry (e.g., the communication circuitry 160 of FIG. 1). For example, the blockchain 310 may mean a data storage environment distributed to the plurality of external objects (or electronic device). For example, the electronic device 101 may identify information on the token obtained by using the blockchain 310. For example, the token may include an NFT. As an example, the information may include transaction detail of the token and/or the information on the owner of the token. For example, one area of the blockchain 310 may be used for a smart contract. The electronic device 101 may identify the information on a user allocated to the token and/or the information on a uniform resource identifier (URI) of metadata (or auxiliary data) by using the data stored in the one area. For example, an area different from the one area may include the information on the metadata.

The electronic device 101 according to an embodiment may receive, from the first external electronic device 103, a signal (e.g., the signal 231 of FIG. 2) for generating the event available in a service provided by the electronic device 101. The signal may include the information on a first token (e.g., NFT or FT (fungible-token) provided from the user 103-2 to generate the event. For example, the electronic device 101 may provide the information on the event to the plurality of external electronic devices (the plurality of external electronic devices 150 of FIG. 1) based on generation of the event. For example, the electronic device 101 may receive the signal (e.g., the signal 251 of FIG. 2) for participating in the event. The signal may include a second token information provided from the user 105-2 of the second external electronic device 105 and/or the information on the electronic wallet 105-1 corresponding to the user 105-2 to participate in the event. For example, the electronic device 101 may record the information on the first token and/or the second token by distributing it to the blockchain 310. For example, the electronic device 101 may receive the signal (e.g., the signal 271 of FIG. 2) for monitoring the event. The signal may include the information on the user 107-2. For example, the electronic device 101 may identify the plurality of users 103-2, 105-2, and 107-2 based on first information included in the signals.

For example, the first information may include the first token information, the information on the user 103-2, 105-2, 107-2 suggesting the event, the information on the electronic wallets 103-1, 105-1, 107-1 corresponding to users 103-2, 105-2, 107-2, and/or a share ratio of the user 103-2 related to the generation of the event. For example, the electronic device 101 may obtain a third token (e.g., NFT), corresponding to the first information, and linked to the blockchain 310. For example, the electronic device 101 may issue (or mint) the third token by linking to the blockchain 310 based on performance of the event.

For example, the third token may be an example of the token obtained by burning at least some of the first token provided by the user 103-2 to generate the event. For example, the burning may mean matching at least some of the first token to an electronic wallet different from the electronic wallets 103-1, 105-1, and 107-1. For example, the different electronic wallet may be an example of the electronic wallet that restricts access of the plurality of users, including the users 103-2, 105-2, and 107-2. Based on the burning, the electronic device 101 may reduce the distribution of the first token and/or the third token.

For example, the electronic device 101 may identify the second information based on the performance of the event. The second information may include the first information, a third token information obtained according to the performance of the event, and/or the share ratio of the users 103-2, 105-2, and 107-2. For example, the electronic device 101 may provide a platform for transacting the first token with the plurality of external electronic devices (e.g., the plurality of external electronic devices 150 of FIG. 1). For example, the electronic device 101 may identify that the third token, provided by the user 103-2 to generate the event, is transacted based on the blockchain. Based on the second information corresponding to the third token, the electronic device 101 may match the electronic wallets 103-1, 105-1, 107-1 corresponding to each of the plurality of users, to the second information indicating that the virtual currency based on the transaction of the token is allocated.

The electronic device 101 according to an embodiment may allocate, based on completion of the event, each of the first token provided from the user 103-2 suggesting the event, the second token provided from the user 105-2 participating in the event, and/or the third token obtained according to the performance of the event to the electronic wallets 103-1, 105-1, and 107-1 corresponding to the users 103-2, 105-2, and 107-2. For example, the electronic device 101 may burn some of the first token. For example, the electronic device 101 may allocate another portion of the first token which is different from the burnt portion, to the electronic wallets 105-1 and 107-1 corresponding to each of users 105-2 and 107-2. For example, the electronic device 101 may allocate the second token to the electronic wallet 103-1 corresponding to the user 103-2. For example, the electronic device 101 may allocate the third token to the electronic wallet 103-1 corresponding to the user 103-1. However, the disclosure is not limited thereto.

As described above, the electronic device 101 may configure a DAO based on the event, using a network and the plurality of external electronic devices 103, 105, and 107. The electronic device 101 may issue the token different from the token by linking to the blockchain 310, using the token provided from the users 103-2, 105-2, and 107-2 of the plurality of external electronic devices 103, 105 and 107 according to the performance of the event. Based on completion of the event, the electronic device 101 may allocate the different token to each of the electronic wallets 103-1, 105-1, and 107-1 corresponding to the users 103-2, 105-2, and 107-2 through one area (e.g., the smart contract) included in the blockchain, based on the information obtained according to the performance of the event. The electronic device 101 may provide the platform capable of autonomously communicating so that the users 103-2, 105-2, and 107-2 of the plurality of external electronic devices 103, 105 and 107 completes the event by configuring the plurality of external electronic devices 103, 105 and 107 and a DAO (e.g., the decentralized autonomous organization) based on the generation of the event.

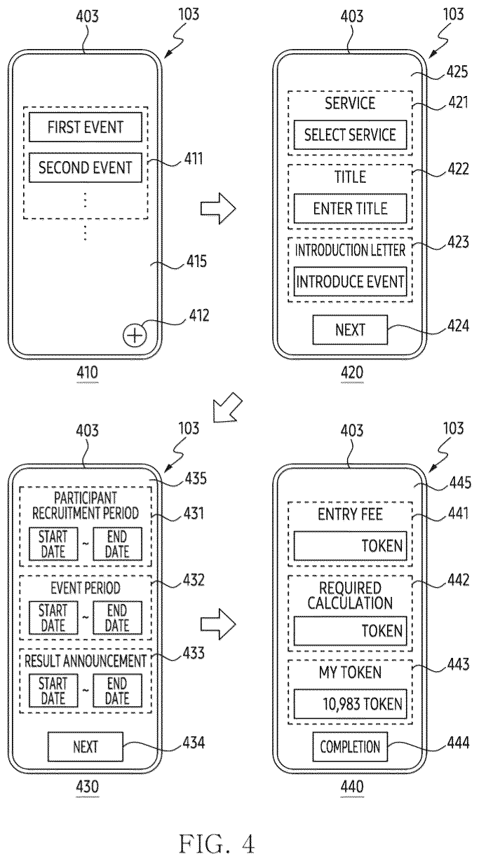

FIG. 4 illustrates an example screen for generating an event by an external electronic device according to an embodiment. Referring to FIG. 4, states 410, 420, 430, and 440 may include a first external electronic device 103 using a service provided by an electronic device 101 of FIG. 1. The first external electronic device 103 may be referred to the first external electronic device 103 of FIG. 1. A display 405 may be referred to the display 155 of FIG. 1.

Referring to FIG. 4, in state 410, the first external electronic device 103 may be an example of a terminal used by a subscriber (e.g., the user 103-2 of FIG. 3) of a service provided by the electronic device (e.g., the electronic device 101 of FIG. 1). The service may be installed in a memory (e.g., the memory 135 of FIG. 1) of the first external electronic device 103. For example, the electronic device (e.g., the electronic device 101 of FIG. 1) may provide a platform for generating the event in the service to a plurality of external electronic devices (e.g., the plurality of external electronic devices 150 of FIG. 1). For example, the first external electronic device 103 may display a screen 415 for generating the event on the display 403 using the platform provided by the electronic device 101. For example, the screen 415 may include an event list 411 suggested by an external electronic device different from the first external electronic device 103. For example, the first external electronic device 103 may identify input indicating selection of a visual object 412 for creating a new event. The first external electronic device 103 may transmit a signal corresponding to the input to the electronic device (e.g., the electronic device 101 of FIG. 1). For example, the event may be an example of the event available in the service provided by electronic device 101. For example, the service may be the service based on a blockchain. For example, the service may be an example of the service related to generation of the token. However, the disclosure is not limited thereto.

For example, the electronic device (e.g., the electronic device 101 of FIG. 1) may transmit information on a screen 425 including a user interface for generating the event to the first external electronic device 103, based on receiving the signal corresponding to the input from the first external electronic device 103.

According to an embodiment, the first external electronic device 103 may display the screen 425 on the display 403, based on the information, received from the electronic device (e.g., the electronic device 101 of FIG. 1) in state 420. For example, the screen 425 may include visual objects 421, 422, 423, and 424. As an example, the visual object 421 may include the information on the plurality of services provided by the electronic device (e.g., the electronic device 101 of FIG. 1). As an example, the visual object 422 may include text information for indicating a name for the event provided in one service selected from among the plurality of the services. However, the disclosure is not limited to the above-described embodiment. As an example, the visual object 421 may include the information on a game-based service, a chat service, a streaming service, a blockchain-based service, and/or a multiverse-based service.

For example, the visual object 423 may contain the text information that is inputted on the event by the user of the first external electronic device 103 and relayed by the electronic device (e.g., the electronic device 101 of FIG. 1) to the plurality of external electronic devices (e.g., the plurality of external electronic devices 150 of FIG. 1) different from the first external electronic device 103. The first external electronic device 103 may identify the input indicating displaying the screen 435 using the visual object 424. The first external electronic device 103 may transmit the signal for the identified input to the electronic device (e.g., the electronic device 101 of FIG. 1).

For example, the electronic device (e.g., the electronic device 101 of FIG. 1) may transmit the signal including the information on the screen 435 to the first external electronic device 103, based on the received signal.

The first external electronic device 103 according to an embodiment may display the screen 435 on the display 403, based on the signal received from the electronic device (e.g., the electronic device 101 of FIG. 1) in state 430. The screen 435 may include visual objects 431, 432, 433, and 434. As an example, the visual object 431 may include the information on a period for recruiting the user (e.g., the user 105-2 of FIG. 3) for participating in the event. As an example, the visual object 432 may include the information on a period for performing the event. As an example, the visual object 433 may include the information on a period for indicating completion of the event to the users related to the event. For example, the first external electronic device 103 may identify the input indicating displaying the screen 445, using the visual object 434. The first external electronic device 103 may transmit the signal for the identified input to the electronic device (e.g., the electronic device 101 of FIG. 1).

For example, the electronic device (e.g., the electronic device 101 of FIG. 1) may transmit the signal different from the signal, including the information on the screen 445, to the first external electronic device 103, based on the signal received from the first external electronic device 103.

The first external electronic device 103 according to an embodiment may display the screen 445 on the display 403, based on the different signal received from the electronic device (e.g., the electronic device 101 of FIG. 1) in state 440. For example, the screen 445 may include visual objects 441, 442, 443, and 444. As an example, the visual object 441 may include the information on the token necessary to participate in the event (e.g., the second token provided by the user 105-2 of FIG. 3). As an example, the visual object 442 may include the information on the token necessary to generate an event (e.g., the first token provided by the user 103-2 of FIG. 3). As an example, the visual object 443 may include the information on the token matched in the electronic wallet 103-1 corresponding to the user (e.g., the user 103-2 of FIG. 3) of the first external electronic device 103. For example, the first external electronic device 103 may identify the input indicating generating the event, using the visual object 444. The first external electronic device 103 may transmit the signal corresponding to the input to the electronic device (e.g., the electronic device 101 of FIG. 1).

The electronic device (e.g., the electronic device 101 of FIG. 1) according to an embodiment may generate the event based on the signal, received from the first external electronic device 103. For example, the electronic device (e.g., the electronic device 101 of FIG. 1) may store data on the generated event in the memory of the electronic device (e.g., the memory 130 of FIG. 1). The data may include the information included in the visual objects 421, 422, 423, 431, 432, 433, 441, and 442. For example, the electronic device (e.g., the electronic device 101 of FIG. 1) may store the data as a resource file based on an operating system. The information on the data stored as the resource file may be referred to in Table 1 of FIG. 2. The electronic device (e.g., the electronic device 101 of FIG. 1) according to an embodiment may record the information on the token included in the visual object 442 in the blockchain (e.g., the blockchain 310 of FIG. 3) by distributing it to the blockchain 310, based on the generation of the event. However, the disclosure is not limited to the above-described embodiment.

The electronic device 101 according to an embodiment may provide the generated event to the plurality of external electronic devices (e.g., the plurality of external electronic devices 150 of FIG. 1) through the network (e.g., the network 190 of FIG. 1). In FIG. 3, identifying participation in the event provided by the electronic device using at least one external electronic device will be described later.

As described above, the electronic device (e.g., the electronic device 101 of FIG. 1) may provide the platform for generating the event to the plurality of external electronic devices. The electronic device (e.g., the electronic device 101 of FIG. 1) may receive the signal indicating the generation of the event by the first external electronic device 103 from among the plurality of external electronic devices. The signal may include the information on the event. The electronic device (e.g., the electronic device 101 of FIG. 1) may store the information as the resource file (or a format) provided by the operating system. The electronic device 101 may record the token included in the information on the event in the blockchain (e.g., the blockchain 310 of FIG. 3). The electronic device (e.g., the electronic device 101 of FIG. 1) may use the token to perform the event. The electronic device (e.g., the electronic device 101 of FIG. 1) may issue the token (e.g., NFT) different from the token by linking to the blockchain, using the used token, based on the performance of the event.

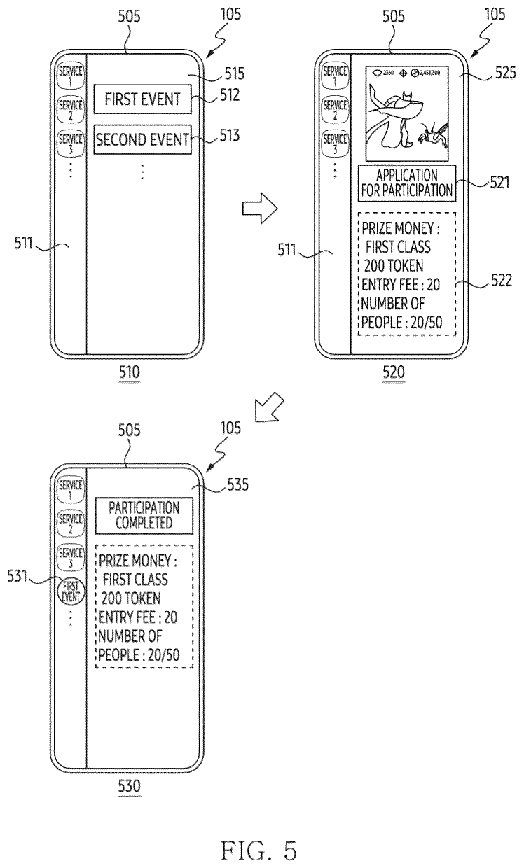

FIG. 5 illustrates an example screen for an external electronic device according to an embodiment to participate in an event. Referring to FIG. 5, states 510, 520, and 530 may include a second external electronic device 105 using a platform provided by the electronic device (e.g., the electronic device 101 of FIG. 1). For example, the second external electronic device 105 may be referred to the second external electronic device 105 of FIG. 1.

Referring to FIG. 5, in state 510, the second external electronic device 105 according to an embodiment may be an example of a terminal used by a subscriber (e.g., the user 105-2 of FIG. 3) of a service provided by the electronic device (e.g., the electronic device 101 of FIG. 1). For example, the electronic device (e.g., the electronic device 101 of FIG. 1) may provide the platform related to the event to a plurality of external electronic devices (e.g., the plurality of external electronic devices 150 of FIG. 1) in the service.

The second external electronic device 105 according to an embodiment may display a screen 515 for participating in the event on the display 505 using the platform provided by the electronic device (e.g., the electronic device 101 of FIG. 1). As an example, a screen 515 may include visual objects 511, 512, and 513. As an example, a visual object 511 may include information on the plurality of services provided by the electronic device (e.g., the electronic device 101 of FIG. 1). As an example, the visual objects 512 and 513 may include the information on each of different events that may be performed in one of the plurality of the services. The second external electronic device 105 may identify input indicating that one of the visual objects 512 and 513 is selected. Based on the identified input, the second external electronic device 105 may transmit a signal corresponding to the input to the electronic device (e.g., the electronic device 101 of FIG. 1).

For example, the electronic device (e.g., the electronic device 101 of FIG. 1), based on the signal received from the second external electronic device 105, may transmit the signal different from the signal, including the information on the selected event, to the second external electronic device 105.

The second external electronic device 105 according to an embodiment may display a screen 525 on the display 505, based on the different signal received from the electronic device (e.g., the electronic device 101 of FIG. 1) in state 520. For example, the screen 525 may include visual objects 511, 521, and 522. As an example, the visual object 522 may include the information on the event. The information on the event may include the information included in the visual objects 421, 422, 423, 431, 432, 433, 441, and 442 of FIG. 4. For example, the information on the event may mean the information included in Table 1 of FIG. 2, which the electronic device (e.g., the electronic device 101 of FIG. 1) stores in a memory (e.g., the memory 130 of FIG. 1). For example, the second external electronic device 105 may identify the input indicating selection of the visual object 521. The second external electronic device 105 may transmit the signal corresponding to the input to the electronic device (e.g., the electronic device 101 of FIG. 1). The signal may include the user (e.g., the user 105-2 of FIG. 3) information of the second external electronic device 105. As an example, in response to (or based on) the identified input, the second external electronic device 105 may transmit data on a token (e.g., the second token provided to participate in the event of FIG. 3) included in an electronic wallet (e.g., the electronic wallet 105-1 of FIG. 3) corresponding to the user (e.g., the user 105-2 of FIG. 3) of the second external electronic device 105, to the electronic device (e.g., the electronic device 101 of FIG. 1).

For example, the electronic device (e.g., the electronic device 101 of FIG. 1) may record the data on the token received from the second external electronic device 105 in a blockchain (e.g., the blockchain 310 of FIG. 3).

The second external electronic device 105 according to an embodiment may display a screen 535 on the display 505 based on the input indicating selection of the visual object 521 in state 530. For example, the screen 535 may include a visual object 531. As an example, the second external electronic device 105 may display a community on the display 505 in response to (or based on) the input indicating selection of the visual object 531. As an example, the community channel is provided by the electronic device (e.g., the electronic device 101 of FIG. 1) and may include the information on the users (e.g., the users 103-2, 105-2, 107-2 of FIG. 3) of the plurality of electronic devices related to the event (e.g., the first external electronic device 103, second external electronic device 105, and/or third external electronic device 107 of FIG. 3).

The electronic device (e.g., the electronic device 101 of FIG. 1) according to an embodiment may receive the information on the user (e.g., the user 105-2 of FIG. 3) participating in the event from the second external electronic device 105. For example, the electronic device (e.g., the electronic device 101 of FIG. 1) may identify the user suggesting the event (e.g., the user 103-2 of FIG. 3), the user participating in the event (e.g., the user 105-2 of FIG. 3), and/or the user for monitoring the event (e.g., the user 107-2 of FIG. 3). For example, the electronic device (e.g., the electronic device 101 of FIG. 1) may obtain the information on the identified users. For example, the electronic device (e.g., the electronic device 101 of FIG. 1) may store the information on the identified user in the memory (e.g., the memory 130 of FIG. 1). For example, the electronic device (e.g., the electronic device 101 of FIG. 1) may generate a DAO including the identified users through at least one network (e.g., the network 190 of FIG. 1).

For example, the electronic device (e.g., the electronic device 101 of FIG. 1) may record the token provided by at least some of the identified users in the blockchain (e.g., the blockchain 310 of FIG. 3). For example, the electronic device (e.g., the electronic device 101 of FIG. 1) may issue (or mint) the token (e.g., NFT) different from the token by linking to the blockchain (e.g., the blockchain 310 of FIG. 3), using the token, based on the performance of the event. For example, the electronic device (e.g., the electronic device 101 of FIG. 1) may match the issued different token to each of the electronic wallets (e.g., the electronic wallets 103-1, 105-1, 107-1 of FIG. 3) corresponding to the identified users based on the information obtained according to the performance of the event.

As described above, the electronic device (e.g., the electronic device 101 of FIG. 1) may provide the event to the plurality of external electronic devices (e.g., the plurality of external electronic devices 150 of FIG. 1) based on at least one service (e.g., a game service, or a service related to the blockchain). The electronic device (e.g., the electronic device 101 of FIG. 1) may generate the DAO by linking to the plurality of users related to the event to the blockchain. Based on the generated DAO, the electronic device (e.g., the electronic device 101 of FIG. 1) may record the token provided by the plurality of users in the blockchain. The electronic device (e.g., the electronic device 101 of FIG. 1) may allocate the token different from the token issued based on the performance of the event to each of the plurality of users, based on the generated DAO. The electronic device (e.g., the electronic device 101 of FIG. 1) may match the allocated token to each of electronic wallets corresponding to the plurality of users based on identifying completion of the event. The electronic device (e.g., the electronic device 101 of FIG. 1) may configure the plurality of DAOs corresponding to the plurality of available events in the service provided by the electronic device, and may allocate the token issued by the event to the plurality of users included in each of the plurality of DAOs using the block chain corresponding to each of the plurality of DAOs.

FIG. 6 illustrates operations performed by an electronic device, according to an embodiment, that is configured to match electronic wallets to a token. At least one of the operations of FIG. 6 may be performed by the electronic device 101 of FIG. 1 and/or a processor 120 of the electronic device 101.

In operation 610, the processor according to an embodiment may identify the plurality of users related to an event using communication circuitry. For example, the communication circuitry may be referred to the communication circuitry 140 of FIG. 1. For example, the event may be included in a service (e.g., a game service, a metaverse service, and/or a chat service) that the processor provides to the plurality of external electronic devices (e.g., the plurality of external electronic devices 150 of FIG. 1) through a network (e.g., the network 190 of FIG. 1). For example, the plurality of users related to the event may include the user suggesting the event (e.g., the user 103-2 of FIG. 3), the user participating in the event (e.g., the user 105-2 of FIG. 3), and/or the user for monitoring the event (e.g., the user 107-2 of FIG. 3). The processor may generate a DAO through the network (e.g., the network 190 of FIG. 1) based on the plurality of users.

In operation 620, the processor according to an embodiment may receive first information related to performance of the event from at least one of the plurality of users. For example, the first information may include at least one of the signals 231, 271, 251, and 237 of FIG. 2. For example, the first information may include the information on the plurality of users and/or token information provided from the plurality of users.

In operation 630, the processor according to an embodiment may obtain the token, corresponding to the first information, and linked to a blockchain distributed to the plurality of external electronic objects. For example, the blockchain may be referred to the blockchain 310 of FIG. 3. For example, the token may be an example of the token (e.g., NFT) issued according to the performance of the event. For example, the processor may obtain the information indicating that the token linked to the blockchain, corresponding to the first information, is allocated to each of the plurality of users.

In operation 640, the processor according to an embodiment, in response to (or based on) identifying that the token is transacted based on the blockchain, based on the first information corresponding to the token, may match the electronic wallets corresponding to each of the plurality of users, to second information indicating that a virtual currency is allocated based on a transaction of the token. For example, the processor may perform matching the second information to the electronic wallets based on identifying completion of the event. For example, the processor may provide a platform for transacting the token to the plurality of external electronic devices (e.g., the first external electronic device 103 of FIG. 1, the second external electronic device 105 of FIG. 1, and/or the third external electronic device 107 of FIG. 1) corresponding to the plurality of users. For example, the processor may identify the transaction based on the blockchain in the platform. For example, the electronic wallets may be referred to the electronic wallets 103-1, 105-1, and 107-1 of FIG. 3. For example, the virtual currency may be provided to the plurality of external electronic devices (e.g., the plurality of external electronic devices 150 of FIG. 1) through the network (e.g., the network 190 of FIG. 1) by the electronic device linked to the blockchain. For example, according to the performance of the event provided by the processor, the second information may be obtained. For example, the second information may include the information on the plurality of users (e.g., the users 103-2, 105-2, 107-2 of FIG. 3) related to the event, the token information provided by the users, share ratio of the users for the event, and/or the information on the electronic wallet corresponding to the users.

As described above, the electronic device and/or processor may generate the event using the service provided by the electronic device. The electronic device and/or processor may identify the plurality of users related to the generated event. The electronic device and/or processor may generate the DAO by linking to at least one blockchain, using the identified plurality of users. Based on the generated DAO, the electronic device and/or processor may record the token provided from the identified plurality of users in the at least one blockchain. The electronic device and/or processor may obtain the token different from the token, using the token by linking to the blockchain. The electronic device and/or processor may allocate the issued different token to the electronic wallets corresponding to each of the plurality of users, based on the DAO.

In a computer readable storage medium storing one or more programs according to an embodiment, the one or more programs, when executed by a processor of an electronic device, may identify a plurality of users related to an event using communication circuitry of the electronic device. The one or more programs may receive first information related to performance of the event from at least one of the plurality of users. The one or more programs may obtain a token, corresponding to the received the first information, and linked to a blockchain distributed to the plurality of external electronic devices. The one or more programs, in response to (or based on) identifying that the token is transacted based on the blockchain, based on the first information corresponding to the token, may match electronic wallets corresponding to each of the plurality of users, to second information indicating that a virtual currency is allocated based on a transaction of the token.

For example, in the one or more programs, first users suggesting the event from among the plurality of users, may provide at least one of the first information or a second token different from a first token, wherein the second token is the token to generate the event. The one or more programs, when executed by the processor of the electronic device, may generate the event, based on at least one of the first information or the second token.

For example, the one or more programs, when executed by the processor of the electronic device, based on performance of the event, may obtain the second information, including the first information, and corresponding to each of the plurality of users.

For example, the first token may include non-fungible token (NFT). The one or more programs, when executed by the processor of the electronic device, based on the first information, may obtain the NFT.

For example, the one or more programs, when executed by the processor of the electronic device, may match at least one of the first token, to first electronic wallets corresponding to each of the first users from among the electronic wallets, and the second information. The one or more programs may match the second token, to second electronic wallets corresponding to each of second users, participating in the event, and different from the first users, based on the second information.

For example, the second users may provide a third token based on the first information in order to participate in the event.

For example, the one or more programs, when executed by the processor of the electronic device, may allocate the first token to the first information including data for identifying the first users and one or more third users designated for monitoring the event from among the plurality of users.

For example, the one or more programs, when executed by the processor of the electronic device, may perform burning at least some of the second token based on completion of the event.

For example, the one or more programs, when executed by the processor of the electronic device, based on burning the at least some of the second token, may obtain the first token.

For example, the event may be provided to subscribers of a service provided by the electronic device.

For example, the service may include at least one of a game service, a chat service, or a service based on a blockchain.

A method of an electronic device according to an embodiment may include identifying a plurality of users related to an event using communication circuitry of the electronic device. The method may include receiving first information related to performance of the event from at least one of the plurality of users. The method may include obtaining a token, corresponding to the received first information, and linked to a blockchain distributed to a plurality of external electronic devices. Based on identifying that the token is transacted based on the blockchain and based on the first information corresponding to the token, the method may include matching electronic wallets corresponding to each of the plurality of users, to second information indicating that a virtual currency is allocated based on a transaction of the token.

For example, first users suggesting the event from among the plurality of users, may provide at least one of the first information or a second token different from a first token, wherein the second token is the token to generate the event. The method may include generating the event, based on at least one of the first information or the second token.

For example, the method, based on performance of the event, may include obtaining the second information, including the first information, and corresponding to each of the plurality of users.

For example, the first token may include non-fungible token (NFT). The method, based on the first information, may obtaining the NFT.

For example, the method may include matching at least one of the first token, to first electronic wallets corresponding to each of the first users from among the electronic wallets, and the second information. The method may include matching the second token, to second electronic wallets corresponding to each of second users, participating in the event, and different from the first users, based on the second information.

For example, the method may include allocating the first token to the first information including data for identifying the first users and one or more third users designated for monitoring the event from among the plurality of users.

For example, the method may include performing burning at least some of the second token based on completion of the event.

For example, the method, based on burning the at least some of the second token, may include obtaining the first token.

For example, the event may be provided to subscribers of a service provided by the electronic device.

For example, the event may include a quest provided to subscribers of a game service provided by the electronic device.

In a computer readable storage medium storing one or more programs according to an embodiment, the one or more programs, when executed by a processor of an electronic device, based on receiving, using communication circuitry of the electronic device, first information for generating an event from one of a plurality of users, may generate the event. The one or more programs may receive second information related to performance of the generated event from one of the plurality of users. The one or more programs, based on at least one of the first information or the second information, may obtain a token, generated by the performance of the event, and linked to a blockchain distributed to a plurality of external electronic devices. The one or more programs may match the token, to electronic wallets corresponding to each of the plurality of users based on identifying completion of the event.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to (or based on) the execution of the software. In an embodiment, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include may be those configured to store program instructions, including a magnetic medium such as a hard disk, floppy disk, and magnetic tape, optical recording medium such as a CD-ROM and DVD, magneto-optical medium, such as a floptical disk, and ROM, RAM, flash memory, and the like. In addition, examples of other media may include recording media or storage media managed by app stores that distribute applications, sites that supply or distribute various software, servers, and the like.

As described above, although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

What is claimed is:

1. A computer readable storage medium storing one or more programs, wherein the one or more programs that, when executed by a processor of an electronic device, are configured to:
identify, using communication circuitry of the electronic device, a plurality of users related to an event;
receive first information related to performance of the event from at least one of the plurality of users;
obtain a token, corresponding to the received first information, and linked to a blockchain distributed to a plurality of external electronic devices; and
based on identifying that the token is transacted based on the blockchain, and based on the first information corresponding to the token, match electronic wallets corresponding to each of the plurality of users, to second information indicating that a virtual currency is allocated based on a transaction of the token.

2. The computer readable storage medium of claim 1, wherein first users suggesting the event from among the plurality of users, provide at least one of the first information or a second token different from a first token, wherein the second token is the token to generate the event, and
wherein the one or more programs that, when executed by the processor of the electronic device, are configured to generate the event, based on at least one of the first information or the second token.

3. The computer readable storage medium of claim 2, wherein the one or more programs that, when executed by the processor of the electronic device, are further configured to, based on performance of the event, obtain the second information, wherein the second information comprises the first information, and the second information corresponds to each of the plurality of users.

4. The computer readable storage medium of claim 3, wherein the first token comprises non-fungible token (NFT), and
wherein the one or more programs that, when executed by the processor of the electronic device, are further configured to, based on the first information, obtain the NFT.

5. The computer readable storage medium of claim 4, wherein the one or more programs that, when executed by the processor of the electronic device, are further configured to:
match at least one of the first token, to first electronic wallets corresponding to each of the first users from among the electronic wallets, and the second information, and
based on the second information, match the second token, to second electronic wallets corresponding to each of second users, wherein the second users participate in the event, and the second users are different from the first users

6. The computer readable storage medium of claim 5, wherein the second users provide a third token based on the first information in order to participate in the event

7. The computer readable storage medium of claim 2, wherein the one or more programs that, when executed by the processor of the electronic device, are further configured to allocate the first token to the first information comprising data for identifying the first users and one or more third users designated for monitoring the event from among the plurality of users.

8. The computer readable storage medium of claim 7, wherein the one or more programs that, when executed by the processor of the electronic device, are further configured to perform burning at least one second token based on completion of the event.

9. The computer readable storage medium of claim 8, wherein the one or more programs that, when executed by the processor of the electronic device, are further configured to, based on burning the at least one second token, obtain the first token.

10. The computer readable storage medium of claim 1, wherein the event is provided to subscribers of a service provided by the electronic device

11. A method of an electronic device, the method comprising,
identifying, using communication circuitry of the electronic device, a plurality of users related to an event;
receiving, from at least one of the plurality of users, first information related to performance of the event;
obtaining a token that corresponds to the received first information, and that is linked to a blockchain distributed to a plurality of external electronic devices; and
based on identifying that the token is transacted based on the blockchain, and based on the first information corresponding to the token, matching electronic wallets corresponding to each of the plurality of users, to second information indicating that a virtual currency is allocated based on a transaction of the token.

12. The method of claim 11, wherein first users suggesting the event from among the plurality of users, provide at least one of the first information or a second token, wherein the second token is different from a first token and the second token is the token to generate the event, and
wherein the method further comprises generating the event, based on at least one of the first information or the second token.

13. The method of claim 12, further comprising, based on performance of the event, obtaining the second information, wherein the second information comprises the first information, and the second information corresponds to each of the plurality of users.

14. The method of claim 13, wherein the first token comprises non-fungible token (NFT), and
wherein the method further comprises, based on the first information, obtaining the NFT.

15. The method of claim 14, comprising;
matching at least one of the first token, to first electronic wallets corresponding to each of the first users from among the electronic wallets, and the second information, and
based on the second information, matching the second token, to second electronic wallets corresponding to each of second users, wherein the second users participate in the event, and the second users are different from the first users.

16. The method of claim 12, further comprising allocating the first token to the first information comprising data for identifying the first users and one or more third users designated for monitoring the event from among the plurality of users.

17. The method of claim 16, comprising performing burning at least one second token based on completion of the event.

18. The method of claim 17, comprising, based on the burning the at least one second token, obtaining the first token.

19. The method of claim 11, wherein the event is provided to subscribers of a service provided by the electronic device.

20. A computer readable storage medium storing one or more programs, wherein the one or more programs that, when executed by a processor of an electronic device, are configured to:
based on receiving, using communication circuitry of the electronic device, first information for generating an event from one of a plurality of users, generate the event;
receive second information related to performance of the generated event from one of the plurality of users;
based on at least one of the first information or the second information, obtain a token, wherein the token is generated by the performance of the event, and the token is linked to a blockchain distributed to a plurality of external electronic devices; and
based on identifying completion of the event, match the token to electronic wallets corresponding to each of the plurality of users.
